(19) United States
(12) Patent Application Publication
(10) Pub. No.: US 2018/0056247 A1
(43) Pub. Date: Mar. 1, 2018

(54) PVDF POWDER FOR LIQUID SLURRIES

(71) Applicant: Arkema Inc., King of Prussia, PA (US)

(72) Inventor: Walter P. KOSAR, Pottstown, PA (US)

(21) Appl. No.: 15/556,063

(22) PCT Filed: Mar. 8, 2016
(86) PCT No.: PCT/US16/21323

§ 371 Date: Sep. 6, 2017

Related U.S. Application Data
(60) Provisional application No. 62/130,099, filed on Mar. 9, 2015.

(51) Int. Cl. B01D 71/32; B01D 67/00; C08L 27/16; C08L 27/18

(52) U.S. Cl. CPC B01D 71/32; B01D 67/0018; C08F 14/22; C08L 27/18; C08L 27/16

(57) ABSTRACT

The invention relates to polymer powders, preferably fluoropolymer powders such as polyvinylidene fluoride (such as Kynar® resins from Arkema Inc.), polyvinyl fluoride, and poly-ethylene-co-chlorotrifluoroethylene, useful for a high-solids liquid slurry. The PVDF has a narrow average particle size of from 20 to 100 microns, with less than 20 weight percent of particles outside this range. This powder can be used to form slurries having from 30 to 60 weight percent solids, the liquid slurries formed being free-flowing. The free-flowing slurries are useful in forming membranes in a thermally induced phase separation (TIPS) process.

### FIELD OF THE INVENTION

The invention relates to polymer powders, preferably fluoropolymer powders such as polyvinylidene fluoride, polyvinyl fluoride, and poly-ethylene-co-chlorotrifluoroethylene, useful for a stable high-solids liquid slurry. The PVDF has a narrow average particle size of from 20 to 100 microns, with less than 20 weight percent of particles outside this range. This powder can be used to form slurries having from 30 to 60 weight percent solids, the liquid slurries formed being free-flowing. The free-flowing slurries are useful in forming membranes in a thermally induced phase separation (TIPS) process.

### BACKGROUND OF THE INVENTION

Polyvinylidene fluoride (PVDF) resin has become a preferred material for the preparation of water treatment membranes by virtue of its high purity, regulatory approvals, and resistance to many of the oxidants and cleaning chemicals used in this application.

One means to form porous membranes is by a thermally induced phase separation (TIPS) process. Thermally induced phase separation (TIPS) is a process for making porous membranes by using rapid temperature change to induce phase separation in molten or gel-phase solution of a polymer and latent solvent and/or plasticizer. Upon cooling, the mixture becomes thermodynamically unstable with respect to demixing, and phase separation results. This process differs from non-solvent induced phase separation in that the phase separation is not driven by non-solvent influx.

TIPS membranes are very desirable due to their high mechanical strength and durability. The polymer in the TIPS process will generally not dissolve at ambient temperature in the latent solvent, and therefore these mixtures will be heterogeneous, with undissolved polymer present. At high solids content, the mixtures can become very thick pastes. The sticky paste or tacky solid is hard to dispense in automated production equipment. The sticky nature of formulations in the 40-50% solids range makes this technology difficult to practice and prone to production upsets when feeding is not uniform.

There is a need to formulate a polymer resin into a free flowing liquid mixture for industrial scale processing. Liquid slurries can be easily pumped and metered, either by volume or mass. Liquid feeding is usually more accurate and reliable than powder feeding, especially if the powder is sticky with adsorbed solvent.

Surprisingly it has been found that flowable polymer-solvent slurry mixtures at a 40-50% solids composition range can be formed using PVDF powder having a narrow particle size range and an average particle size of 20-100 microns.

### SUMMARY OF THE INVENTION

The invention relates to a liquid dispersion slurry comprising:

a) from 30 to 50 weight percent of fluoropolymer particles, having an average particle size of from 20 to 100 microns, with less than 20 weight percent of the particles being outside this range, and

b) a latent solvent,

c) optionally, from 0 to 25 weight percent of one or more additives,

wherein said liquid dispersion slurry is free-flowing at room temperature.

The invention also relates to a process to make a porous membrane from the liquid slurry.

The invention further relates to porous membranes formed from the liquid slurry of the invention.

### DETAILED DESCRIPTION OF THE INVENTION

This invention relates to a unique particle size range of PVDF resin that allows for easy dispersion into latent solvents to produce a free flowing liquid mixture.

As used herein, unless otherwise indicated, molecular weight means weight average molecular weight, and percents are weight percents. All references cited are incorporated herein by reference.

### Polymer

The polymer of the invention can be any polymer used for forming membranes by the TIPS process. Especially useful polymers are fluoropolymers. Especially useful fluoropolymers include, but are not limited to the homo- and copolymers having a majority of monomer units being either vinylidene fluoride or vinyl fluoride, ethylene tetrafluroethylene (ETFE), and ethylenechloro trifluoroethylene (ECTFE). The invention will use polyvinylidene fluoride as an exemplary fluoropolymer, but one of skill in the art can easily envision using polyvinyl fluoride, ETFE, ECTFE and other similar polymers with the same parameters described.

The polyvinylidene fluoride resin composition of the invention may be a homopolymer made by polymerizing vinylidene fluoride (VDF), copolymers, terpolymers and higher polymers of vinylidene fluoride wherein the vinylidene fluoride units comprise greater than 70 percent of the total weight of all the monomer units in the polymer, and more preferably, comprise greater than 75 percent of the total weight of the units. Copolymers, terpolymers and higher polymers of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, hexafluoropropene, trifluoromethyl-methacrylic acid, trifluoromethyl methacrylate, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene. Preferred copolymers or terpolymers are formed with vinyl fluoride, trifluoroethene, tetrafluoroethene (TFE), and hexafluoropropene (HFP) and vinyl acetate. While an all fluoromonomer containing copolymer is preferred, non-fluorinated monomers such as vinyl acetate, methacrylic acid, and acrylic acid, may also be used to form copolymers, at levels of up to 15 weight percent based on the polymer solids.

Preferred copolymers are of VDF comprising from about 71 to about 99 weight percent VDF, and correspondingly from about 1 to about 29 percent TFE; from about 71 to 99 weight percent VDF, and correspondingly from about 1 to 29 percent HFP (such as disclosed in U.S. Pat. No. 3,178,399); and from about 71 to 99 weight percent VDF, and correspondingly from about 1 to 29 weight percent trifluoroethylene.

Preferred terpolymers are the terpolymer of VDF, HFP and TFE, and the terpolymer of VDF, trifluoroethene, and TFE, The especially preferred terpolymers have at least 71 weight percent VDF, and the other comonomers may be present in varying portions, but together they comprise up to 29 weight percent of the terpolymer.

The polyvinylidene fluoride could also be a functionalized PVDF, produced by either copolymerization or by post-polymerization functionalization. Additionally the PVDF could be a graft copolymer, such as, for example, a radiation-grafted maleic anhydride copolymer. Hydrophilic polymers are also useful in the invention.

Mixtures of polyvinylidene fluoride polymer is also envisioned as part of the invention, including functionalized polymers with non-functionalized polymers, and polymers having different molecular weights.

The high-solids, flowable liquid slurries require polymers of the proper particle size and particle size distribution. The average polymer particle size, as determined by a Microtrac particle size analyzer is from 20 to 200 microns, preferably from 25 to 150 microns, more preferably from 25 to 120 microns, and most preferably from 30 to 100 microns, with at least 60 weight percent, preferably at least 70 weight percent, and most preferably 80 weight percent of the particles falling within this range. Finer powders (in the 10 um or less particle size range) form thick pastes at solids contents in the 40-50% range. The fine powder form is often too powdery to handle well and also does not fuse out well in certain sintering applications. Coarser powders (>200 um) similarly form thick pastes, and they will also settle out from the solvent over time. The 20-200 um particle size range allows for preparation of free flowing liquid slurries at higher solids content.

There are several ways to obtain polymer particle sizes meeting the criteria of the invention. One could use polymer pellets and then grind them and classify them into the desired particle size range. This process could either be run at ambient temperature or run cryogenically, depending on the type of polymer. Either a disk attrition mill or a hammer mill can be used to provide the size reduction, with standard screens being used to classify the resin.

In one embodiment, granular PVDF (such as Kynar® PVDF) has been milled to make smaller and more uniform particle size products. These granular Kynar® grades handle much better than fine powder.

In another embodiment a compacted or densified form of the polymer powder can be used as a starting material. Such densified resin may be produced in a roll compaction mill followed by coarse granulation into a size range 0.4 to 4.0 mm. This coarse densified polymer powder may then be further reduced in size by use of either a jet mill, an air classifying impact mill (ACM), or a disk attrition mill. Unlike polymer pellets (which often require cryo-grinding to convert to powder) the densified polymer powder is much more friable and readily reduced in size without expensive cryo-grinding. The jet mill was particularly effective and reducing the particle size to below 50 um, while the disk attrition mill was capable of producing powder in the 50-300 um range. The particle size distribution can be controlled during manufacturing by setting the top size screen.

### Solvent

The polymer particles are blended with latent solvents, to form the free-flowing, high solids slurry. Latent solvents are organic liquids which does not dissolve (less than 5% by weight soluble) or substantially swell the fluoropolymer resin at room temperature, but will dissolve the fluoropolymer resin at elevated temperatures.

Solvents that will dissolve the polymer are not preferred, and this will lead to a viscosity increase. Useful solvents include, but are not limited to, dimethyl phthalate, diethylphthalate, dibutylphthalate, isoctylphthalate, dibutylsebacate, triethylcitrate, tributylcitrate, acetyl-tributylcitrate, glycerol triacetate (Triacetin), glycerol tributyrate (Tributyrin), cyclohexanone, propylene carbonate, gamma-butyrolactone, ethyl-lactate, butyl-lactate, ethyllevulinate, n-octylpyrrolidone, triethyl phthalate, N-methyl-2-pyrrolidone, dimethylformamide, N,N-dimethylacetamide, dimethylsulfoxide (DMSO), hexamethylphosphamide, dioxane, tetrahydrofuran, tetramethylurea, triethyl phosphate, trimethyl phosphate, dimethyl succinate, diethyl succinate and tetraethyl urea, gamma valerolactone, and mixtures thereof. Preferred solvents are the di- and tri-alkyl phthalates, and especially diethyl phthalate, dimethyl phthalate, and dibutyl phthalate.

N-methyl-2-pyrrolidone. Other useful fugitive adhesion promoter agents include, but are not limited to, dimethylformamide, N,N-dimethylacetamide, dimethylsulfoxide (DMSO), hexamethylphosphamide, dioxane, tetrahydrofuran, tetramethylurea, triethyl phosphate, trimethyl phosphate, dimethyl succinate, diethyl succinate and tetraethyl urea.

### Other Additives

In addition to the fluoropolymer and solvent, one or more other additives may be added to the membrane composition, typically at from 1 to 20 weight percent and more preferably from 5 to 10 weight percent, based on the total solids composition. Preferably the additives have average particle sizes in the range of 1 to 250 microns, and more preferably from 5 to 100 microns, and most preferably from 10 to 50 microns. Typical additives include, but are not limited to, acrylic polymer, water-soluble pore-formers which are typically hydrophilic water extractable compounds such as metallic salts (such as lithium, calcium and zinc salts), alcohols, glycols (such as polyethylene glycol, polypropylene glycol, and glycerol); silica, alumina, zirconia, zinc oxide, calcium carbonate, iron oxide, activated carbon, carbon nanotubes, or other similar inorganic fillers. Other hydrophilic additives include polyvinylpyrrolidone, poly-2-ethyloxazoline, polyvinylacetate, and polyvinyl alcohol.

The fluoropolymer, solvent and additives are blended together to provide a stable slurry. By “stable slurry” as used herein is meant that the polymer/latent solvent slurries are blended for 5 minutes using hand whisk, or egg beater, and allowed to sit for 24 hours. Stable slurries will show no visible separation or clear supernatant layer on top of settles solids.

The stable liquid slurry can be formed into porous membranes by a means known in the art. The solids level of the slurry (polymer plus additives) should be from 30 to 60 weight percent of the polymer (PVDF), and from 0 to 20 weight percent of the other additives, with the total solids preferably in the range of 35 to 60, and preferably from 40 to 50 weight percent.

The TIPS process is described above, and is the preferred process for forming a membrane using the liquid slurry of the invention. A thermally baked coating is also a preferred application of the invention. The solvent slurry of the invention is free-flowing at room temperature, allowing for the transfer of the slurry in the manufacturing process into the extruder. By “free-flowing” as used herein means that the liquid slurry has a viscosity in the range of from 300 to 4000 cps, and preferably from 500-1500 cps, as measured by a Brookfield DV-II plus Pro Extra using a #2 spindle for a 45 percent by weight PVDF slurry diethylphthalate, at 20° C., and 50 rpm.

The porous membranes can be in the form of flat sheets, supported sheets, tubes, or hollow fibers.

The final dry thickness of the membranes of this invention are generally between 50 to 500 microns, and preferably from 100 to 250 microns. This can be measured using a cryofractured membrane in a scanning electron microscope, or an optical microscope using a calibrated eye-piece or sizing software.

### EXAMPLES

Viscosity was measured Brookfield DV-II plus Pro Extra using a #2 spindle for these measurements for a 45 percent by weight PVDF slurry diethylphthalate, at 20° C., and 50 rpm.

The stability test: Blend up slurries for 5 minutes using hand whisk, or egg beater. Let slurry sit for 24 hours. Stable slurries will show no visible separation or clear supernatant layer on top of settles solids.

The range/mean value was calculated based on the particle size range in the 10-90% values of the particle size distribution, divide by the mean particle size. Preferably, for the stable slurries of the present invention, the range/mean ratio is from 2.0 to 4.0, and more preferably from 2.3 to 3.7. For a comparative reference, SOLEF 6010 from Solvay gave a 0.842 value.

### Example 1

A 500 g slurry of PVDF resin in diethylphthalate was prepared with a series of resins with different particle sizes. The mixture contained 45% PVDF resin and 55% diethylphthalate. Diethylphthalate was first weighed out into a mixing jar, followed by addition of PVDF resin. The mixture was stirred up for 1 minute using a hand wisk to disperse the solids. The mixtures were allowed to sit for 2 hours to fully wet with solvent. The mixtures were then mixed again for 1 minute using a hand held electric powered wisk mixer. This more completely blended the resins into the solvent.

The slurries were then tested for viscosity on a Brookfield viscometer using a #2 spindle at 50 rpm at ambient temperature.

The mixtures were also monitored for separation while they sat. The results are tabulated in Table 1 below.

TABLE 1

| Resin | | | | | |
|---|---|---|---|---|---|
| Powder | | | | | |
| particle | | | | | |
| size, um | Form | Viscosity | Torque % | Stability | Range/mean |
| 10 | paste | | | Stable but | |
| | | | | intractable | |
| 50 | slurry | 794 | 12.4 | stable | 3.517 |
| 100 | slurry | 909 | 14.2 | stable | 2.753 |
| 200 | slurry | 879 | 13.6 | Slow | 1.196 |
| | | | | settling | |
| 800 | Coarse | 700 | 14 | Rapid | |
| | slurry | | | settling | |

The results show that the 50 um and 100 um average PSD slurries had the best stability to settling and were not too viscous to prevent pumping in slurry process. The mixtures with 50 um and 100 um powders did not settle out over this time. The 200 um sample showed slight settling over this time, and the fully granular sample settled out significantly.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Aspects of the invention include:

1. A stable liquid dispersion slurry comprising:

a) from 30 to 60 weight percent, and preferably from 35 to 55 weight percent of fluoropolymer particles, wherein said particles have a weight average particle size of from 20 to 200 microns, preferably from 25 to 150 microns, more preferably from 25 to 120 microns, and more preferably from 30 to 100 microns, with at least 60 weight percent, preferably at least 70 weight percent, and most preferably at least 80 weight percent of the particles being within this range, and

b) a latent solvent,

c) optionally, from 0 to 25 weight percent of one or more additives,

wherein said liquid dispersion slurry is free-flowing at room temperature.

2. The liquid dispersion slurry of aspect 1, wherein said fluoropolymer is selected from a polyvinylidene fluoride homopolymer, a polyvinylidene fluoride copolymer having at least 60 weight percent of vinylidene fluoride monomer units, a vinyl fluoride homo polymer, a polyvinyl fluoride copolymer having at least 60 weight percent of vinyl fluoride monomer units, tetrafluroethylene (ETFE), and ethylene-co-chloro trifluoroethylene (ECTFE).
3. The liquid slurry as described in aspect 1, wherein said additives have an average particle size of from 1 to 250 microns and are selected from the group consisting of acrylic polymer, water-soluble pore-formers which are typically hydrophilic water extractable compounds such as metallic salts, lithium salts, calcium salts and zinc salts, alcohols, glycols, polyethylene glycol, polypropylene glycol, and glycerol, silica, alumina, zirconia, zinc oxide, calcium carbonate, iron oxide, activated carbon, carbon nanotubes, or other similar inorganic fillers.
4. The liquid slurry of aspect 1, wherein said polymer content ranges from 30% to 45%, and additives range from 1% to 25% by weight.
5. The liquid slurry of aspect 1, wherein said latent solvent is selected from the group consisting of diethylphthalate, dibutylphthalate, ioctylphthalate, dibutylsebacate, triethylcitrate, tributylcitrate, acetyl-tributylcitrate, glycerol triacetate, glycerol tributyrate, cyclohexanone, propylene carbonate, gamma-butyrolactone, ethyl-lactate, butyl-lactate, ethyllevulinate, n-octylpyrrolidone, triethyl phthalate, gamma valerolactone, and mixtures thereof.
6. A process to make a porous membranes using the liquid slurries described in aspect 1 using thermally induced phase separation.
7. The process of aspect 6, wherein the process for making said porous membrane is a thermally induced phase separation (TIPS) process.
8. A porous membrane formed from the liquid dispersion slurry of aspect 1.
9. The porous membrane of aspect 8, wherein said membrane is in the form of a flat sheet, supported flat sheet, tube, or hollow fiber.

1. A stable liquid dispersion slurry comprising:
a) from 30 to 50 weight percent of fluoropolymer particles, wherein said particles have a weight average particle size of from 20 to 200 microns, with at least 60 weight percent of the particles being within this range, and
b) a latent solvent,
c) optionally, from 0 to 25 weight percent of one or more additives,
wherein said liquid dispersion slurry is free-flowing at room temperature.

2. The liquid dispersion slurry of claim 1, wherein said fluoropolymer is selected from a polyvinylidene fluoride homopolymer, a polyvinylidene fluoride copolymer having at least 60 weight percent of vinylidene fluoride monomer units, a vinyl fluoride homo polymer, a polyvinyl fluoride copolymer having at least 60 weight percent of vinyl fluoride monomer units, tetrafluroethylene (ETFE), and ethylene-co-chloro trifluoroethylene (ECTFE).

3. The liquid dispersion of claim 1, wherein said fluoropolymer particles have an average particle size of from 25 to 150 microns, with at least 60 weight percent of the particles being within this range.

4. The liquid dispersion of claim 3, wherein said fluoropolymer particles have an average particle size of from 25 to 120 microns, with at least 70 weight percent of the particles being within this range.

5. The liquid dispersion of claim 4, wherein said fluoropolymer particles have an average particle size of from 30 to 100 microns, with at least 70 weight percent of the particles being within this range.

6. The liquid dispersion slurry of claim 1, wherein said dispersion slurry has a solids content of from 35 to 55 weight percent.

7. The liquid slurry as described in claim 1, wherein said additives have an average particle size of from 1 to 250 microns and are selected from the group consisting of acrylic polymer, water-soluble pore-formers which are typically hydrophilic water extractable compounds such as metallic salts, lithium salts, calcium salts and zinc salts, alcohols, glycols, polyethylene glycol, polypropylene glycol, and glycerol, silica, alumina, zirconia, zinc oxide, calcium carbonate, iron oxide, activated carbon, carbon nanotubes, or other similar inorganic fillers.

8. The liquid slurry of claim 1, wherein said polymer content ranges from 30% to 45%, and additives range from 1% to 25% by weight.

9. The liquid slurry of claim 1, wherein said latent solvent is selected from the group consisting of diethylphthalate, dibutylphthalate, ioctylphthalate, dibutylsebacate, triethylcitrate, tributylcitrate, acetyl-tributylcitrate, glycerol triacetate, glycerol tributyrate, cyclohexanone, propylene carbonate, gamma-butyrolactone, ethyl-lactate, butyl-lactate, ethyllevulinate, n-octylpyrrolidone, triethyl phthalate, gamma valerolactone, and mixtures thereof.

10. A process to make a porous membranes using the liquid slurries described in claim 1 using thermally induced phase separation.

11. The process of claim 10, wherein the process for making said porous membrane is a thermally induced phase separation (TIPS) process.

12. A porous membrane formed from the liquid dispersion slurry of claim 1.

13. The porous membrane of claim 12, wherein said membrane is in the form of a flat sheet, supported flat sheet, tube, or hollow fiber.
